(19) United States
(12) Patent Application Publication
(10) Pub. No.: US 2024/0005906 A1
(43) Pub. Date: Jan. 4, 2024

(54) INFORMATION PROCESSING DEVICE, INFORMATION PROCESSING METHOD, AND INFORMATION PROCESSING COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi (JP)

(72) Inventors: Yoshinori KURATA, Moriya (JP); Shigenobu SETO, Yokohama (JP); Hisao YOSHIOKA, Chofu (JP)

(73) Assignees: KABUSHIKI KAISHA TOSHIBA, Tokyo (JP); TOSHIBA DIGITAL SOLUTIONS CORPORATION, Kawasaki-shi (JP)

(21) Appl. No.: 18/467,762

(22) Filed: Sep. 15, 2023

Related U.S. Application Data
(63) Continuation of application No. PCT/JP2022/002004, filed on Jan. 20, 2022.

(30) Foreign Application Priority Data
Mar. 18, 2021 (JP) 2021-045181

(51) Int. Cl. G10L 13/08; G06F 40/242; G10L 25/60

(52) U.S. Cl. CPC G10L 13/08; G06F 40/242; G10L 25/60

(57) ABSTRACT

An information processing device (10) includes a hardware processor configured to function as an output unit (24). The output unit (24) outputs second script data in which dialogue data of a dialogue included in first script data is associated with utterer data of an utterer of the dialogue from the first script data as a basis for performance.

### CROSS-REFERENCE TO RELATED APPLICATIONS

This application is a continuation of PCT International Application No. PCT/JP2022/002004 filed on Jan. 20, 2022 which claims the benefit of priority from Japanese Patent Application No. 2021-045181, filed on Mar. 18, 2021, the entire contents of which are incorporated herein by reference.

### FIELD

Embodiments described herein relate generally to an information processing device, an information processing method, and an information processing computer program product.

### BACKGROUND

There is known a voice synthesis technique of converting text into voice to be output. For example, there is known a system that creates synthesized voices of various utterers from input text, and outputs the synthesized voices. There is also known a technique of reproducing onomatopoeia depicted in comics.

A script as a basis for performance has a configuration including various pieces of information such as names of utterer's roles and stage directions in addition to dialogues to be actually uttered. In the related art, a technique of synthesizing voices for performance in accordance with an intention of the script has not been disclosed. That is, in the related art, data with which performance voice in accordance with an intention of the script can be output has not been provided.

### BRIEF DESCRIPTION OF THE DRAWINGS

FIG. 1 is a diagram illustrating an example of an information processing device according to an embodiment;

FIG. 2 is a schematic diagram of an example of a script;

FIG. 3 is a schematic diagram of an example of a data configuration of second script data;

FIG. 4 is a schematic diagram of an example of a UI screen;

FIG. 5 is a schematic diagram illustrating an example of a data configuration of third script data;

FIG. 6 is a schematic diagram of an example of a data configuration of performance voice data;

FIG. 7 is a flowchart representing an example of a procedure of output processing for the second script data;

FIG. 8 is a flowchart representing an example of a procedure of generation processing for the third script data;

FIG. 9 is a flowchart representing an example of a procedure of generation processing for the performance voice data; and

FIG. 10 is a hardware configuration diagram.

### DETAILED DESCRIPTION

An object of the present disclosure is to provide an information processing device, an information processing method, and an information processing computer program product that can provide data with which performance voice in accordance with an intention of a script can be output.

An information processing device according an embodiment includes a hardware processor configured to function as an output unit configured to output second script data in which dialogue data of a dialogue included in first script data is associated with utterer data of an utterer of the dialogue from the first script data as a basis for performance. The following describes an information processing device, an information processing method, and an information processing computer program product in detail with reference to the attached drawings.

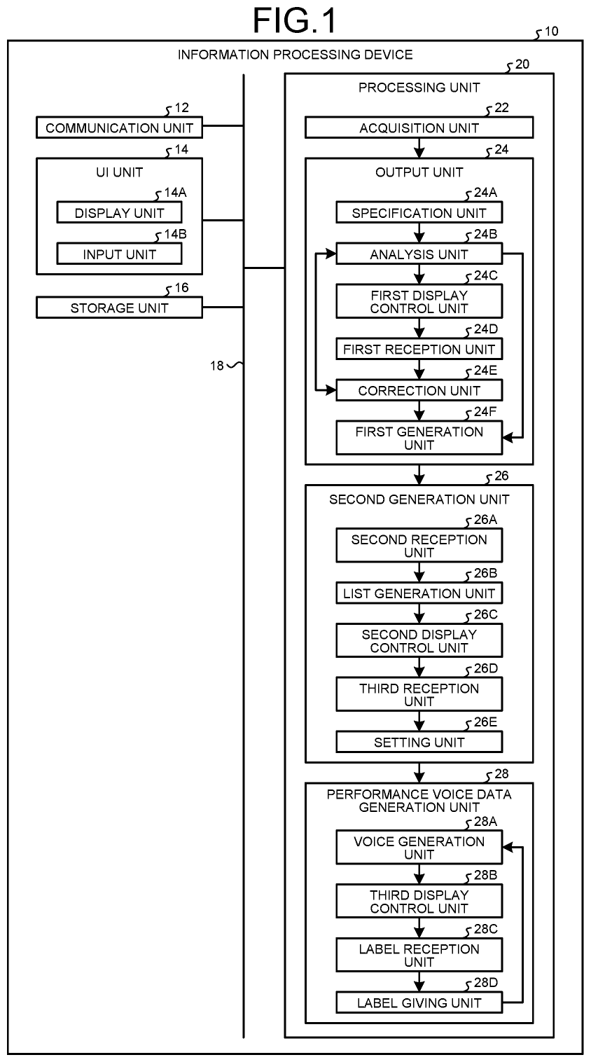

FIG. 1 is a diagram illustrating an example of an information processing device 10 according to an embodiment.

The information processing device 10 is an information processing device that generates data with which performance voice in accordance with an intention of a script can be output.

The information processing device 10 includes a communication unit 12, a user interface (UI) unit 14, a storage unit 16, and a processing unit 20. The communication unit 12, the UI unit 14, the storage unit 16, and the processing unit 20 are connected to be able to communicate with each other via a bus 18.

The communication unit 12 communicates with other external information processing devices via a network and the like. The UI unit 14 includes a display unit 14A and an input unit 14B. The display unit 14A is, for example, a display such as a liquid crystal display (LCD) or an organic electro-luminescence (EL) display, or a projection device. The input unit 14B receives a user's operation. The input unit 14B is, for example, a pointing device such as a digital pen, a mouse, or a trackball, or an input device such as a keyboard. The display unit 14A displays various pieces of information. The UI unit 14 may be a touch panel integrally including the display unit 14A and the input unit 14B.

The storage unit 16 stores various pieces of data. The storage unit 16 is, for example, a semiconductor memory element such as a random access memory (RAN) and a flash memory, a hard disk, and an optical disc. The storage unit 16 may be a storage device that is disposed outside the information processing device 10. The storage unit 16 may also be a storage medium. Specifically, the storage medium may be a storage medium that has stored or temporarily stored a computer program or various pieces of information that have been downloaded via a local area network (LAN), the Internet, or the like. The storage unit 16 may be constituted of a plurality of storage media.

Next, the following describes the processing unit 20. The processing unit 20 executes various pieces of information processing. The processing unit 20 includes an acquisition unit 22, an output unit 24, a second generation unit 26, and a performance voice data generation unit 28. The output unit 24 includes a specification unit 24A, an analysis unit 24B, a first display control unit 24C, a first reception unit 24D, a correction unit 24E, and a first generation unit 24F. The second generation unit 26 includes a second reception unit 26A, a list generation unit 26B, a second display control unit 26C, a third reception unit 26D, and a setting unit 26E. The performance voice data generation unit 28 includes a voice generation unit 28A, a third display control unit 28B, a label reception unit 28C, and a label giving unit 28D.

Each of the acquisition unit 22, the output unit 24, the specification unit 24A, the analysis unit 24B, the first display control unit 24C, the first reception unit 24D, the correction unit 24E, the first generation unit 24F, the second generation unit 26, the second reception unit 26A, the list generation unit 26B, the second display control unit 26C, the third reception unit 26D, the setting unit 26E, the performance voice data generation unit 28, the voice generation unit 28A, the third display control unit 28B, the label reception unit 28C, and the label giving unit 28D is implemented by one or a plurality of processors, for example. For example, each of the units described above may be implemented by causing a processor such as a central processing unit (CPU) to execute a computer program, that is, by software. Each of the units described above may also be implemented by a processor such as a dedicated integrated circuit (IC), that is, by hardware. Each of the units described above may also be implemented by using both of software and hardware. In a case of using a plurality of processors, each of the processors may implement one of the units, or may implement two or more of the units.

At least one of the units described above may be mounted on a cloud server that executes processing on a cloud.

The acquisition unit 22 acquires first script data.

The first script data is data of a script as a basis for performance. The script is a book for the purpose of performance, and may be any of a paper medium and electronic data. The script may be a concept including a screenplay and a drama.

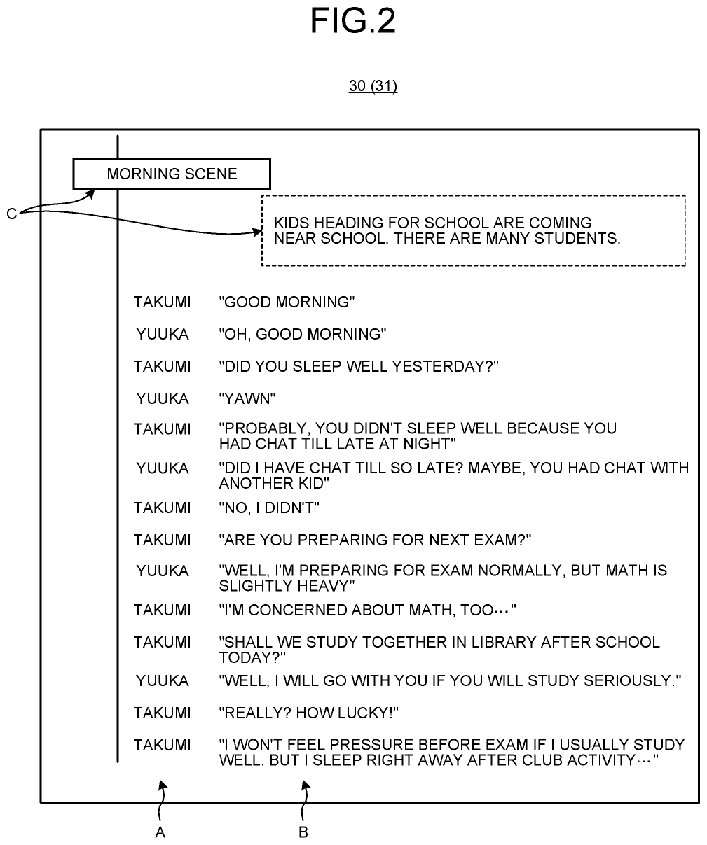

FIG. 2 is a schematic diagram of an example of a script 31. The script 31 includes additional information such as dialogues, names of utterers who utter the dialogues, and stage directions. The dialogue is words uttered by an utterer appearing in a play or a creation to be performed. The utterer is a user who utters the dialogue. The stage directions are portions other than the dialogues and the names of the utterers in the script 31. The stage direction is, for example, a situation of a scene, lighting, designation of effects such as music, movement of the utterer, or the like. The stage direction is described between the dialogues, for example.

In the present embodiment, each dialogue is treated for words uttered in one time of utterance by one utterer. Due to this, the script 31 includes one or a plurality of the dialogues. In the present embodiment, a form in which the script 31 includes a plurality of the dialogues is exemplified.

There are various arrangement positions of the dialogue, the name of the utterer, the stage direction, and the like included in the script 31. FIG. 2 illustrates a mode in which an arrangement region A of the utterers is disposed in a region on the left side within a sheet surface of the script 31. FIG. 2 illustrates the mode in which the script 31 includes “Takumi (Person A)” and “Yuuka (Person B)” as the names of the utterers as an example. Additionally, FIG. 2 illustrates the mode in which an arrangement region B of the respective dialogues of the utterers for the names of the utterers is disposed on the right side following the arrangement region A of the names of the utterers. FIG. 2 also illustrates the mode in which an arrangement region C of the stage directions is disposed on the top end within the sheet surface of the script 31. The position of the arrangement region C is on the top of the sheet surface and the distance of this position from the leftmost end of the sheet surface differs from those of the names of the utterers and the dialogues. In the script 31, there are various arrangement positions of the dialogues, the names of the utterers, the stage directions, and the like, and various description forms such as a type, a size, and a color of a font. That is, script patterns representing at least arrangement of the names of the utterers and the dialogues are different depending on the script 31.

Returning to FIG. 1, the description will be continued. In a case in which the script 31 is a paper medium, the acquisition unit 22 of the information processing device 10 acquires first script data 30 as electronic data obtained by reading the script 31 by a scanner and the like. The acquisition unit 22 may acquire the first script data 30 by reading the first script data 30 that has been pre-stored in the storage unit 16. The acquisition unit 22 may also acquire the first script data 30 by receiving the first script data 30 from an external information processing device via the communication unit 12. The script 31 may also be electronic data. In this case, the acquisition unit 22 acquires the first script data 30 by reading the script 31 as electronic data.

The output unit 24 outputs second script data obtained by associating dialogue data of the dialogue included in the first script data 30 with utterer data of the utterer of the dialogue from the first script data 30. The utterer data is data of the name of the utterer.

In the present embodiment, the output unit 24 includes the specification unit 24A, the analysis unit 24B, the first display control unit 24C, the first reception unit 24D, the correction unit 24E, and the first generation unit 24F.

The specification unit 24A specifies a script pattern of the first script data 30. The script pattern at least represents an arrangement of the utterers and the dialogues included in the script 31 of the first script data 30.

As described above with reference to FIG. 2, in the script 31, there are various arrangement positions of the dialogues, the names of the utterers, the stage directions, and the like, and various description forms such as a type, a size, and a color of a font depending on the script 31.

Thus, the specification unit 24A specifies the script pattern of the first script data 30 acquired by the acquisition unit 22. For example, the specification unit 24A pre-stores, in the storage unit 16, a plurality of the script patterns that are different from each other. The specification unit 24A analyzes arrangement of characters and character strings included in the first script data 30, and description forms such as a font and a color by analyzing the characters included in the first script data 30 by optical character recognition (OCR) and the like. The specification unit 24A then specifies the script pattern of the first script data 30 by specifying, from the storage unit 16, a script pattern that is the most similar to the analyzed arrangement and description forms of the characters and the character strings.

Alternatively, the specification unit 24A may prepare a plurality of pairs of the first script data 30 and the script pattern of the first script data 30 in advance, and use these pairs as teacher data to learn a learning model. The specification unit 24A then inputs the first script data 30 acquired by the acquisition unit 22 to the learning model. The specification unit 24A may specify the script pattern of the first script data 30 as an output of the learning model. This learning model is an example of a second learning model described later.

The analysis unit 24B analyzes dialogue data and utterer data included in the first script data 30 acquired by the acquisition unit 22 based on the script pattern specified by the specification unit 24A. For example, it is assumed that the specification unit 24A specifies the script pattern of the script 31 illustrated in FIG. 2.

In this case, the analysis unit 24B analyzes, as the utterer data of the utterer, characters arranged in the arrangement region A of the name of the utterer represented by the specified script pattern among the characters included in the first script data 30. The analysis unit 24B also analyzes, as the dialogue data of the dialogue, characters arranged in the arrangement region B of the dialogue represented by the specified script pattern among the characters included in the first script data 30.

At this point, the analysis unit 24B analyzes, as the dialogue data of the utterer, the characters arranged in the arrangement region B corresponding to the characters of the utterer arranged in the arrangement region A of the name of the utterer. In a case of the example illustrated in FIG. 2, the arrangement region B corresponding to the utterer means characters arranged on the same line in the same character writing direction as that of the characters of the utterer in the arrangement region B of the dialogue with respect to the characters of the utterer arranged in the arrangement region A of the name of the utterer in the script 31. The character writing direction is a direction in which writing of the characters proceeds. FIG. 2 illustrates a mode in which the character writing direction is vertical as an example.

Through these pieces of processing, the analysis unit 24B extracts, for each piece of the dialogue data, the utterer data of the utterer and the dialogue data of the dialogue uttered by the utterer included in the first script data 30. As described above, the dialogue data is the dialogue uttered in one time of utterance by one utterer. Due to this, the analysis unit 24B extracts a pair of the dialogue data and the utterer data of the utterer who utters the dialogue of the dialogue data for each of the dialogues included in the first script data 30.

At the time of analyzing the utterer data included in the first script data 30, the analysis unit 24B may also analyze the utterer data as an estimation result obtained by estimating the utterer who utters the dialogue of the dialogue data based on the dialogue data. For example, the script 31 includes a dialogue for which the name of the utterer is not written in some cases. Additionally, in the script 31, part of the name of the utterer is abbreviated or differently written due to a mistake and the like in some cases. In this case, the analysis unit 24B analyzes the utterer data by estimating the utterer who utters the dialogue data from the dialogue data included in the first script data 30.

For example, the analysis unit 24B analyzes a group of pieces of the dialogue data for which the name of the utterer is specified in the first script data 30, and specifies a characteristic of the dialogue data for each of the names of the utterers included in the first script data 30. The characteristic of the dialogue data is defined by a numerical value representing a characteristic such as a way of speaking. The analysis unit 24B then estimates the utterer data so that the utterer data of the same utterer is associated with each group of the pieces of dialogue data having similar characteristics for the respective pieces of dialogue data included in the first script data 30. Through these processes, the analysis unit 24B can associate the estimated utterer data of the utterer with dialogue data for which the name of the utterer is not written or dialogue data for which the name of the utterer is inconsistently written.

The analysis unit 24B also gives a dialogue identifier (ID) as identification information for identifying the dialogue data to each piece of the dialogue data included in the first script data 30. In a case in which the first script data 30 includes the dialogue ID, the analysis unit 24B specifies the dialogue ID from the first script data 30, and give the dialogue ID to the dialogue data. In a case in which the first script data 30 does not include the dialogue ID, the analysis unit 24B gives the dialogue ID to each piece of the dialogue data included in the first script data 30.

It is preferable that the analysis unit 24B gives the dialogue ID in ascending order following order of appearance of pieces of the dialogue data included in the first script data 30. The order of appearance is the order along a direction from an upstream side toward a downstream side of the character writing direction of the script 31. When the analysis unit 24B gives the dialogue ID following the order of appearance of the dialogue data, the following effect can be obtained. For example, the first script data 30 can be generated so that synthesized voice of the dialogue data is successively output following a flow of the script 31 at the time when the synthesized voice is output by using the performance voice data described later.

The dialogue data included in the first script data 30 includes punctuation marks in some cases. The punctuation mark is a mark added to written language to indicate a delimiter in a sentence or a delimiter in meaning. The punctuation mark is, for example, a period, a question mark, an exclamation mark, an ellipsis mark, or a line feed mark. It is preferable that the analysis unit 24B optimizes the dialogue data extracted from the first script data 30 to be a format that is natural (without a sense of incongruity) as utterance of a person. “Optimize” means optimizing a type or a position of the punctuation mark included in the dialogue data, or inserting a new punctuation mark. For example, the analysis unit 24B generates optimized dialogue data by optimizing the dialogue data extracted from the first script data 30 using a learning model or dictionary data for optimization stored in advance.

The analysis unit 24B may also estimate a feeling of the utterer at the time of uttering the dialogue data. For example, the analysis unit 24B estimates the feeling of the utterer at the time of uttering the dialogue data based on extracted dialogue data, utterer data of the utterer of the dialogue data, stage direction data of a stage direction arranged at a position closest to the dialogue, and the like. For example, the analysis unit 24B pre-learns a learning model for outputting feeling data based on a character string included in the dialogue data, the utterer data of the utterer who utters the dialogue data, and the stage direction data. The analysis unit 24B then inputs, to the learning model, the dialogue data, the utterer data, and the stage direction data extracted from the first script data 30. The analysis unit 24B estimates the feeling data obtained as an output of the learning data as the feeling data of the dialogue data.

Returning to FIG. 1, the description will be continued. The analysis unit 24B outputs, to the first generation unit 24F, a plurality of pieces of the dialogue data included in the first script data 30 and pieces of the utterer data corresponding to the respective pieces of dialogue data as an analysis result. In the present embodiment, the analysis unit 24B outputs, to the first generation unit 24F, pieces of the dialogue data included in the first script data 30, and the dialogue ID, the utterer data, and the feeling data of each piece of the dialogue data.

The first generation unit 24F generates the second script data in which the dialogue data and the utterer data analyzed by the analysis unit 24B are at least associated with each other.

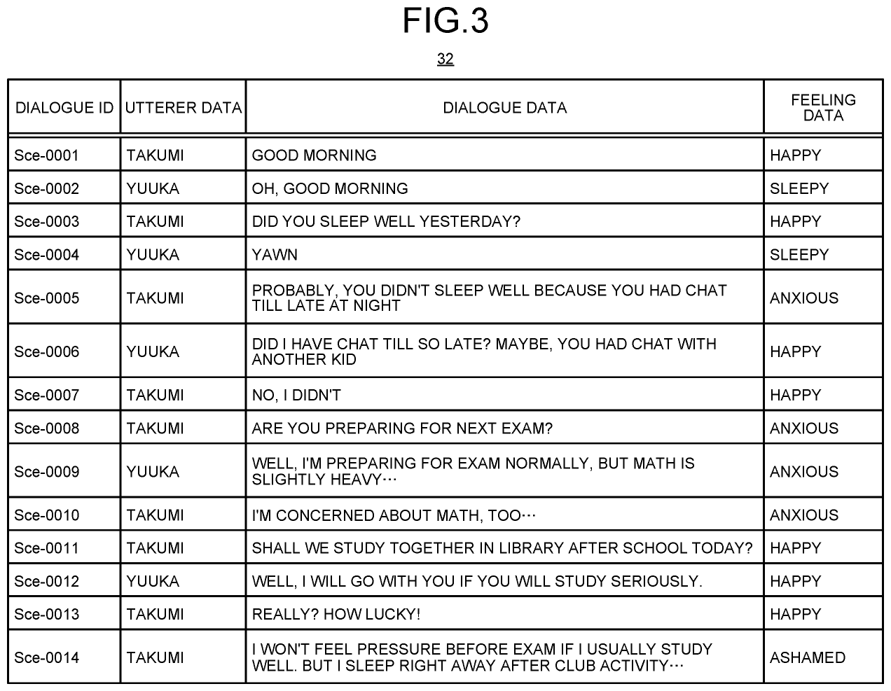

FIG. 3 is a schematic diagram of an example of a data configuration of second script data 32. The second script data 32 is data in which the dialogue ID, the utterer data, and the dialogue data are at least associated with each other. In the present embodiment, exemplified is a mode in which the second script data 32 is data in which the dialogue ID, the utterer data, the dialogue data, and the feeling data are associated with each other.

Returning to FIG. 1, the description will be continued. At this point, an analysis error occurs during analysis of the first script data 30 by the analysis unit 24B in some cases. For example, the first script data 30 includes a character that is difficult to be analyzed in some cases. Additionally, sometimes there is a case in which a character is set in a region not corresponding to the script pattern specified by the specification unit 24A in the first script data 30. In such a case, it is difficult for the analysis unit 24B to normally perform analysis in some cases.

Furthermore, sometimes there is a case in which an error occurs in the analysis result of the utterer data or the dialogue data extracted by analyzing the first script data 30 by the analysis unit 24B.

Thus, at the time of analyzing at least part of the first script data 30, the analysis unit 24B outputs the analysis result to the first display control unit 24C. For example, after analyzing a region corresponding to one page of the script 31 of the first script data 30, the analysis unit 24B outputs the analysis result to the first display control unit 24C. Additionally, in a case in which an analysis error occurs, the analysis unit 24B outputs the analyzed analysis result to the first display control unit 24C.

The first display control unit 24C performs control for displaying the analysis result received from the analysis unit 24B on the display unit 14A. The user can check whether there is an error or a sense of incongruity in the analysis result obtained by the analysis unit 24B by visually recognizing the display unit 14A. In a case of determining that there is a sense of incongruity or an error, the user inputs a correction instruction for the script pattern specified by the specification unit 24A by operating the input unit 14B. For example, by operating the input unit 14B while visually recognizing the display unit 14A, the user inputs the correction instruction for a position, a size, a range, and the like of the arrangement region A of the name of the utterer, the arrangement region B of the dialogue, the arrangement region C of the stage directions, and the like in the script pattern specified by the specification unit 24A.

After receiving the correction instruction, the correction unit 24E corrects the script pattern specified by the specification unit 24A in accordance with the received correction instruction. The correction unit 24E also corrects the second learning model as a learning model that outputs the script pattern from the first script data 30 in accordance with the received correction instruction.

Thus, the correction unit 24E can correct at least one of the script pattern and the learning model so that the dialogue data or the utterer data can be analyzed and extracted more correctly from the first script data 30 of the script 31.

The correction instruction may be a correction instruction for a method of giving the dialogue ID, a method of estimating the feeling data, or a method for estimating the utterer data. In this case, the correction unit 24E corrects an algorithm or a learning model used at each timing such as the time of giving the dialogue ID, the time of estimating the feeling data, and the time of estimating the utterer data in accordance with the received correction instruction.

The analysis unit 24B then analyzes the first script data 30 using at least one of the script pattern, the algorithm, and the learning model after the correction. Through these pieces of processing, the analysis unit 24B can analyze the first script data 30 with higher accuracy. Additionally, the first generation unit 24F can generate the second script data 32 with higher accuracy.

The output unit 24 may be configured not to include the specification unit 24A, the analysis unit 24B, and the first generation unit 24F. In this case, the output unit 24 inputs the first script data 30 to the learning model that outputs the second script data 32 from the first script data 30. This learning model is an example of a first learning model. In this case, the output unit 24 pre-learns the first learning model using, as teacher data, a pair of each of the pieces of first script data 30 and the second script data 32 as correct answer data of each of the pieces of first script data 30. The output unit 24 may then output the second script data 32 as an output result obtained by inputting the first script data 30 acquired by the acquisition unit 22 to the first learning model.

In this case, the correction unit 24E corrects the first learning model that outputs the second script data 32 from the first script data 30 in accordance with the received correction instruction.

The output unit 24 stores the second script data 32 in the storage unit 16. As illustrated in FIG. 3, the second script data 32 output from the output unit 24 is data in which the estimation result of the utterer data included in the first script data 30, the dialogue data in which punctuation marks are optimized, the feeling data, and the dialogue ID are associated with each other.

Each time the acquisition unit 22 acquires a new piece of the first script data 30, the output unit 24 generates the second script data 32 from the first script data 30 to be stored in the storage unit 16. Due to this, one or a plurality of pieces of the second script data 32 are stored in the storage unit 16.

The output unit 24 may further associate information representing a genre or a category of the script 31 with the second script data 32 to be stored in the storage unit 16. For example, the output unit 24 may associate information representing a genre or a category input by operating the input unit 14B by the user with the second script data 32 to be stored in the storage unit 16.

Next, the following describes the second generation unit 26. The second generation unit 26 generates third script data from the second script data 32. The third script data is data obtained by further adding various pieces of information for voice output to the second script data 32. Details about the third script data will be described later.

The second generation unit 26 includes the second reception unit 26A, the list generation unit 26B, the second display control unit 26C, the third reception unit 26D, and the setting unit 26E.

The second reception unit 26A receives designation of the second script data 32 to be edited. The user designates the second script data 32 to be edited by operating the input unit 14B. For example, the user designates a piece of the second script data 32 to be edited among the pieces of second script data 32 stored in the storage unit 16. The second reception unit 26A receives designation of the second script data 32 to be edited by receiving identification information about the designated second script data 32.

The user also inputs designation of units of editing (i.e., unitary editing) at the time of editing work by operating the input unit 14B. For example, the user inputs designation of the units of editing indicating which of the utterer data and the dialogue data is used as the units of editing by operating the input unit 14B. The second reception unit 26A receives designation of the units of editing from the input unit 14B.

The list generation unit 26B reads, from the storage unit 16, the second script data 32 to be edited the designation for which is received by the second reception unit 26A. The list generation unit 26B then classifies the pieces of dialogue data registered in the read second script data 32 into the designated units of editing received by the second reception unit 26A. For example, a case in which the designated unit of editing is the utterer data is assumed. In this case, the list generation unit 26B classifies the dialogue data included in the second script data 32 for each piece of the utterer data.

The second display control unit 26C generates a UI screen in which the second script data 32 to be edited the designation for which is received by the second reception unit 26A is classified into the units of editing generated by the list generation unit 26B. The second display control unit 26C then displays the generated UI screen on the display unit 14A.

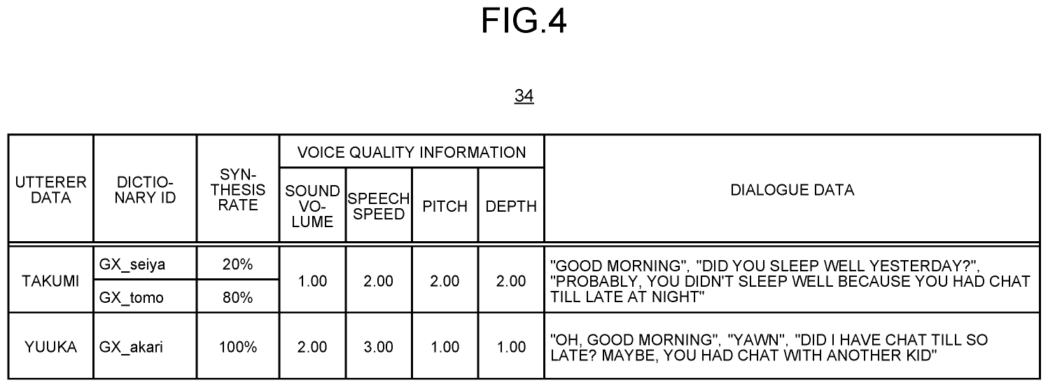

FIG. 4 is a schematic diagram of an example of a UI screen 34. FIG. 4 illustrates the UI screen 34 including at least part of the pieces of dialogue data corresponding to the respective pieces of utterer data for each of “Takumi” and “Yuuka” as the utterer data.

The user inputs the setting information by operating the input unit 14B while visually recognizing the UI screen 34. That is, the UI screen 34 is an input screen for receiving, from the user, an input of the setting information for the dialogue data.

The setting information is information about sound. Specifically, the setting information includes a dictionary ID, a synthesis rate of the dictionary ID, and voice quality information. The setting information only need to be information including at least the dictionary ID. The dictionary ID is dictionary identification information about voice dictionary data. The dictionary identification information is identification information about the voice dictionary data.

The voice dictionary data is a sound model for deriving a sound feature amount from a language feature amount. The voice dictionary data is created in advance for each utterer. The language feature amount is a feature amount of language extracted from text of voice uttered by the utterer. For example, the language feature amount is preceding and following phonemes, information about pronunciation, a phrase-end position, a length of a sentence, a length of an accent phrase, a mora length, a mora position, an accent type, a part of speech, modification information, and the like. The sound feature amount is a feature amount of voice or sound extracted from the voice data uttered by the utterer. As the sound feature amount, for example, a sound feature amount used for hidden Markov model (HMM) voice synthesis may be used. For example, the sound feature amount is a mel-cepstrum coefficient representing a phoneme and a tone of voice, a mel-LPC coefficient, a mel-LSP coefficient, a basic frequency (F0) representing pitch of voice, a non-periodic index (BAP) representing a ratio of periodic components and non-periodic components of voice, and the like.

In the present embodiment, it is assumed that the voice dictionary data corresponding to each of the utterers is prepared in advance, and the voice dictionary data is associated with the dictionary ID to be stored in the storage unit 16 in advance. The utterer corresponding to the voice dictionary data may be identical to the utterer set in the script 31, or is not necessarily identical thereto.

The user inputs the dictionary ID of the voice dictionary data to the dialogue data of the utterer data by operating the input unit 14B while referring to the utterer data and the dialogue data corresponding to the utterer data. Due to this, the user can easily input the dictionary ID while checking the dialogue data.

The user may input dictionary IDs of a plurality of pieces of the voice dictionary data to one piece of the utterer data by operating the input unit 14B. In this case, the user inputs the synthesis rate for each dictionary ID. The synthesis rate represents a ratio of mixing of the voice dictionary data at the time of synthesizing the pieces of voice dictionary data to generate synthesized voice.

Additionally, the user can further input the voice quality information by operating the input unit 14B. The voice quality information is information representing voice quality at the time when the dialogue of the dialogue data corresponding to the utterer data is uttered. In other words, the voice quality information is information representing voice quality of the synthesized voice of the dialogue data. The voice quality information is, for example, represented by a sound volume, a speech speed, pitch, a depth, and the like. The user can designate the voice quality information by operating the input unit 14B.

As described above, the second display control unit 26C displays, on the display unit 14A, the UI screen 34 in which the dialogue data included in the second script data 32 is classified into the units of editing generated by the list generation unit 26B. Thus, the UI screen 34 includes at least part of the pieces of dialogue data corresponding to the respective pieces of utterer data for each of “Takumi” and “Yuuka” as the utterer data. Due to this, the user can input desired setting information to each of the pieces of utterer data while referring to the dialogue data uttered by the utterer of the utterer data.

Returning to FIG. 1, the description will be continued. The third reception unit 26D receives the setting information from the input unit 14B.

The setting unit 26E generates the third script data by setting the setting information received by the third reception unit 26D to the second script data 32.

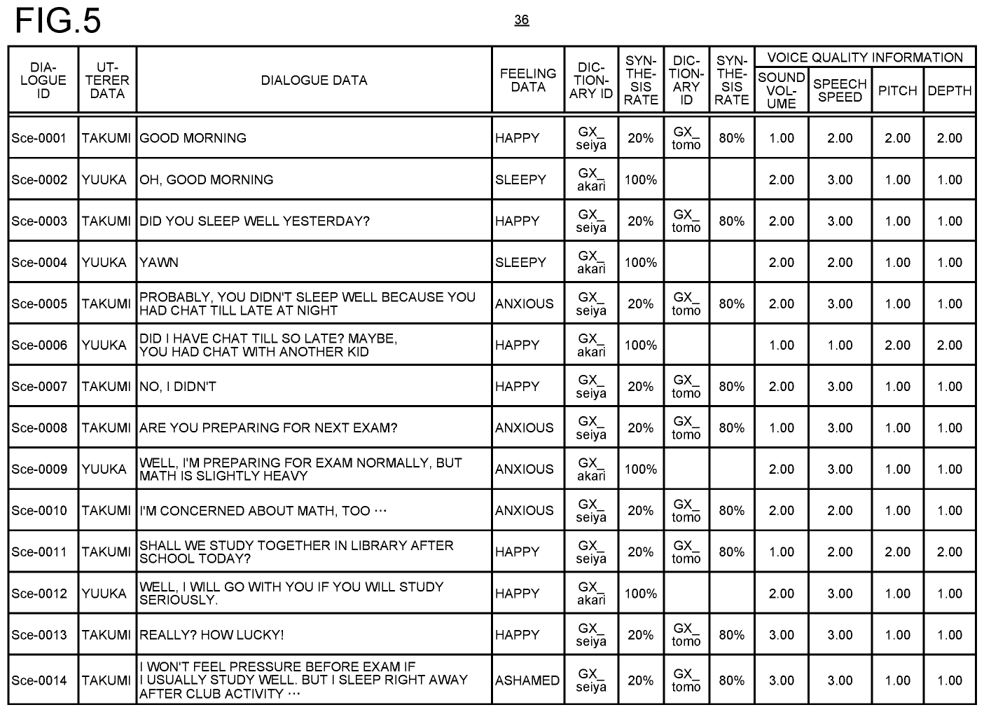

FIG. 5 is a schematic diagram illustrating an example of a data configuration of third script data 36. The third script data 36 is data in which the dialogue ID, utterer data, the dialogue data, the feeling data, the dictionary ID, the synthesis rate, and the voice quality information are associated with each other. The setting unit 26E generates the third script data 36 by associating the setting information corresponding to each of the pieces of utterer data received by the third reception unit 26D with each of the pieces of utterer data in the second script data 32 to be registered. The third script data 36 may be information in which at least the dialogue ID, the utterer data, the dialogue data, and the dictionary ID are associated with each other.

Returning to FIG. 1, the description will be continued. As described above, the second generation unit 26 generates the third script data 36 by associating the setting information for generating the synthesized voice of the utterer of the utterer data input by the user with the utterer data and the dialogue data of the second script data 32 to be registered. The second generation unit 26 stores the generated third script data 36 in the storage unit 16. Thus, the second generation unit 26 stores a newly generated piece of the third script data 36 in the storage unit 16 each time the setting information is input by the user.

Next, the following describes the performance voice data generation unit 28.

The performance voice data generation unit 28 generates the performance voice data from the third script data 36.

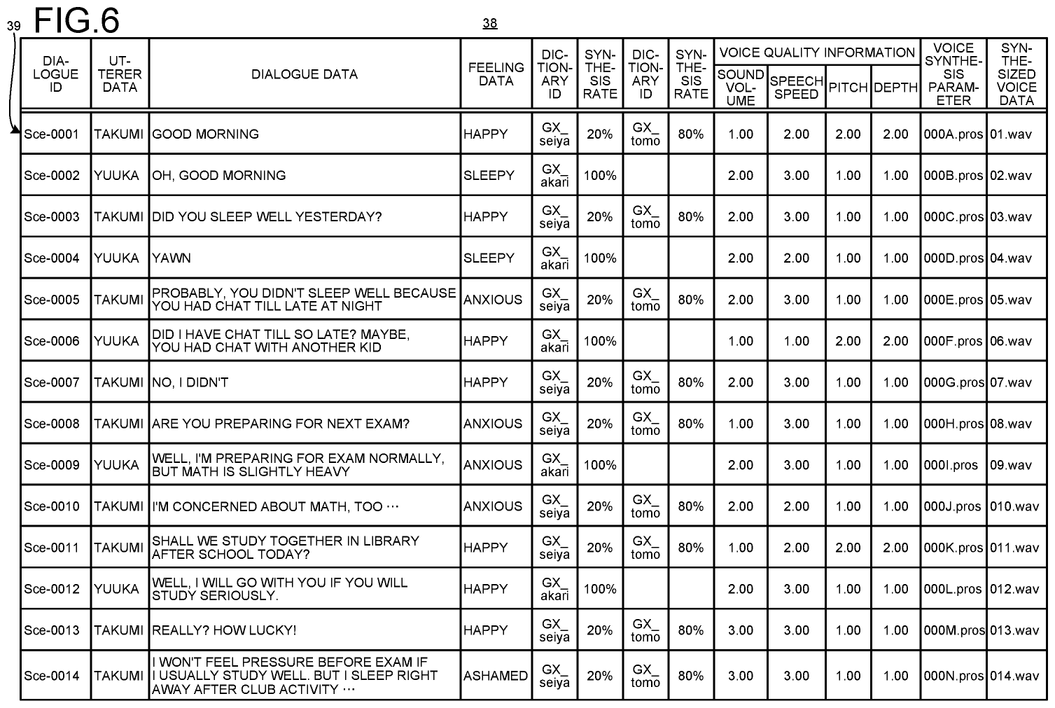

FIG. 6 is a schematic diagram of an example of a data configuration of performance voice data 38. The performance voice data 38 is data in which at least one of a voice synthesis parameter and synthesized voice data is further associated with each of the pieces of dialogue data included in the third script data 36. FIG. 6 illustrates a form in which the performance voice data 38 includes both of the voice synthesis parameter and the synthesized voice data.

That is, the performance voice data 38 includes a plurality of pieces of dialogue voice data 39. The dialogue voice data 39 is data generated for each piece of the dialogue data. In the present embodiment, the dialogue voice data 39 is information in which one dialogue ID, the utterer data, the dialogue data, the feeling data, the dictionary ID, the synthesis rate, the voice quality information, the voice synthesis parameter, and the synthesized voice data are associated with each other. Thus, the performance voice data 38 has a configuration including the same number of pieces of the dialogue voice data 39 as the number of pieces of the included dialogue data.

The voice synthesis parameter is a parameter for generating synthesized voice of the dialogue data using the voice dictionary data that is identified with a corresponding dictionary ID. Specifically, the voice synthesis parameter is Prosody data or the like treated by a voice synthesis module. The voice synthesis parameter is not limited to the Prosody data.

The synthesized voice data is voice data of synthesized voice generated by the voice synthesis parameter. FIG. 6 exemplifies a case in which a data format of the synthesized voice data is a Waveform Audio File Format (WAV). However, the data format of the synthesized voice data is not limited to the WAV file format.

In the present embodiment, the performance voice data generation unit 28 includes the voice generation unit 28A, the third display control unit 28B, the label reception unit 28C, and the label giving unit 28D.

The voice generation unit 28A reads a piece of the third script data 36 to be a generation target for the performance voice data 38. For example, when a new piece of the third script data 36 is stored in the storage unit 16, the performance voice data generation unit 28 reads the piece of the third script data 36 as the third script data 36 as the generation target. Alternatively, the performance voice data generation unit 28 may read, as the third script data 36 as the generation target for the performance voice data 38, the third script data 36 designated by the user by an operation instruction on the input unit 14B.

The voice generation unit 28A generates, for the read third script data 36, the voice synthesis parameter and the voice data for each of the pieces of dialogue data included in the third script data 36.

For example, the voice generation unit 28A executes the following processing for each of the pieces of dialogue data corresponding to the respective dialogue IDs. The voice generation unit 28A generates, for the dialogue data, the voice synthesis parameter of the voice data that is implemented by using the voice dictionary data identified with a corresponding dictionary ID with a corresponding synthesis rate. The voice generation unit 28A further generates the voice synthesis parameter such as Prosody data corresponding to the dialogue data by correcting the generated voice synthesis parameter in accordance with corresponding feeling data and voice quality information.

Similarly, the voice generation unit 28A executes the following processing for each of the pieces of dialogue data corresponding to the respective dialogue IDs. The voice generation unit 28A generates, for the dialogue data, the synthesized voice data that is implemented by using the voice dictionary data identified with a corresponding dictionary ID with a corresponding synthesis rate. The voice generation unit 28A further generates the synthesized voice data corresponding to the dialogue data by correcting the generated synthesized voice data in accordance with corresponding feeling data and voice quality information.

The performance voice data generation unit 28 may pre-learn a learning model that receives the dialogue data, the voice dictionary data, the synthesis rate, the feeling data, and the voice quality information as inputs, and outputs the voice synthesis parameter and the synthesized voice data. The performance voice data generation unit 28 then inputs, to the learning model, the dialogue data, the voice dictionary data, the synthesis rate, the feeling data, and the voice quality information for each of the pieces of dialogue data included in the third script data 36. The performance voice data generation unit 28 may generate the voice synthesis parameter and the synthesized voice data corresponding to each of the pieces of dialogue data as an output from the learning model.

The third display control unit 28B displays the dialogue voice data 39 generated by the voice generation unit 28A on the display unit 14A. For example, the display unit 14A displays the dialogue voice data 39 that has just been generated in the performance voice data 38 illustrated in FIG. 6.

The user inputs one or a plurality of labels for the dialogue voice data 39 by operating the input unit 14B while referring to the displayed dialogue voice data 39.

The label is a label added to the dialogue voice data 39, and is a keyword related to content of the dialogue voice data 39. The label is, for example, a word such as happy, tired, morning, and midnight. The user can give one or a plurality of labels to a piece of the dialogue voice data 39.

The label reception unit 28C receives, from the input unit 14B, the label input by the user and the dialogue ID included in the dialogue voice data 39 to which the label is given. The label giving unit 28D associates the label received by the label reception unit 28C with the received dialogue ID to be registered in the dialogue voice data 39.

Due to this, one or a plurality of labels are given to the performance voice data 38 for each of the pieces of dialogue voice data 39, that is, for each of the pieces of utterer data and dialogue data, or each pair of the utterer data and the dialogue data.

When the label is given to the dialogue voice data 39, retrieval of the dialogue voice data 39 can be performed using the label as a retrieval key. For example, the user desires to give the voice synthesis parameter or the synthesized voice data that has been created to another similar piece of the dialogue data in some cases. In such a case, when retrieval is performed for the dialogue voice data 39 using the dialogue data as a retrieval key, it is difficult in some cases to retrieve an appropriate piece of the dialogue voice data 39 in a case in which a plurality of similar pieces of dialogue data are included therein. On the other hand, when the label is given at the time when the performance voice data 38 is generated, retrieval can be performed for the dialogue voice data 39 using the label as the retrieval key. Due to this, the voice synthesis parameter or the synthesized voice data that has been already created can be easily and appropriately reused. Additionally, an editing time can be shortened.

The label giving unit 28D may automatically generate the label representing the dialogue data to be given to the dialogue voice data 39 by analyzing text included in the dialogue data included in the dialogue voice data 39.

The voice generation unit 28A, the third display control unit 28B, the label reception unit 28C, and the label giving unit 28D of the performance voice data generation unit 28 execute the processing described above for each of the pieces of dialogue data included in the third script data 36. Thus, the performance voice data generation unit 28 successively stores, in the storage unit 16, the dialogue voice data 39 in which the label is associated with at least one of the voice synthesis parameter and the synthesized voice data for each of the pieces of dialogue data included in the third script data 36. The performance voice data generation unit 28 then generates the performance voice data 38 by generating the dialogue voice data 39 for each of the pieces of dialogue data included in the third script data 36.

As illustrated in FIG. 6, the performance voice data 38 is data in which the utterer data is associated with at least one of the voice synthesis parameter and the synthesized voice data for each of the pieces of dialogue data. Due to this, performance voice can be easily output in accordance with an intention of the script 31 by inputting the performance voice data 38 to a well-known synthesized voice device that outputs synthesized voice.

For example, the synthesized voice device successively outputs the synthesized voice data of the dialogue data in the performance voice data 38 along arrangement of the dialogue IDs of the performance voice data 38. Due to this, the synthesized voice device can easily successively output the synthesized voice representing exchange of dialogues along a flow of the script 31 by using the performance voice data 38. A form of performance by the synthesized voice device using the performance voice data 38 is not limited. For example, the performance voice data 38 can be applied to the synthesized voice device that provides a computer graphics (CG) movie, an animation, voice distribution, a reading service for listening to a book (Audible), and the like.

Next, the following describes information processing executed by the information processing device 10 according to the present embodiment.

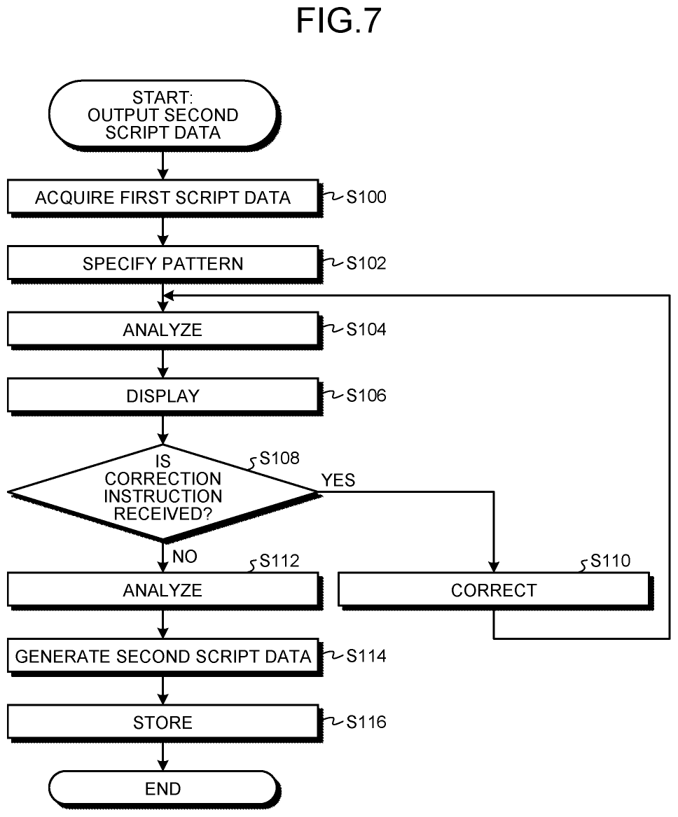

FIG. 7 is a flowchart representing an example of a procedure of output processing for the second script data 32.

The acquisition unit 22 acquires the first script data 30 (Step S100). The specification unit 24A specifies the script pattern of the first script data 30 acquired at Step S100 (Step S102).

The analysis unit 24B analyzes the dialogue data and the utterer data included in the first script data 30 acquired at Step S100 based on the script pattern specified at Step S102 (Step S104). For example, the analysis unit 24B analyzes a part corresponding to one page of the script 31 of the first script data 30.

Next, the first display control unit 24C displays an analysis result obtained at Step S104 on the display unit 14A (Step S106). The user checks whether there is an error or a sense of incongruity in the analysis result obtained by the analysis unit 24B by visually recognizing the display unit 14A. In a case of determining that there is a sense of incongruity or an error, the user inputs a correction instruction for the script pattern specified by the specification unit 24A by operating the input unit 14B.

The correction unit 24E determines whether a correction instruction is received from the input unit 14B (Step S108). In a case of receiving the correction instruction, the correction unit 24E corrects at least one of the script pattern, the learning model, and the algorithm used for analysis (Step S110). The process then returns to Step S104 described above.

On the other hand, in a case of receiving an instruction signal indicating that correction is not required (No at Step S108), the process proceeds to Step S112.

At Step S112, the analysis unit 24B analyzes the entire first script data 30 (Step S112). Specifically, in a case in which correction is not required, the analysis unit 24B analyzes the entire first script data 30 using at least one of a script pattern without correction, the algorithm, and the learning model. In a case in which correction is required, the analysis unit 24B analyzes the entire first script data 30 using at least one of the script pattern, the algorithm, and the learning model after correction at Step S110.

The first generation unit 24F generates the second script data 32 in which the dialogue data and the utterer data, which are analyzed by the analysis unit 24B through the processing at Step S104 to Step S112, are at least associated with each other (Step S114). The first generation unit 24F then stores the generated second script data 32 in the storage unit 16 (Step S116). This routine is then ended.

Next, the following describes a procedure of generating the third script data 36.

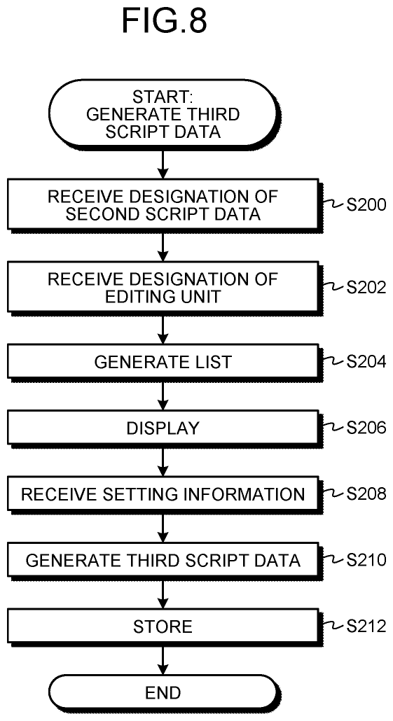

FIG. 8 is a flowchart representing an example of a procedure of generation processing for the third script data 36.

The second reception unit 26A receives designation of the second script data 32 to be edited (Step S200). The user designates the second script data 32 to be edited by operating the input unit 14B. The second reception unit 26A receives designation of the second script data 32 to be edited by receiving identification information about the designated second script data 32.

The second reception unit 26A also receives designation of the units of editing at the time of editing work (Step S202). For example, the user inputs designation of the units of editing indicating which of the utterer data and the dialogue data is used as the units of editing by operating the input unit 14B. The second reception unit 26A receives designation of the units of editing from the input unit 14B.

The list generation unit 26B generates a list (Step S204). The list generation unit 26B generates the list by classifying the pieces of dialogue data registered in the second script data 32 the designation for which is received at Step S200 into the units of editing the designation for which is received at Step S202.

The second display control unit 26C displays the UI screen 34 on the display unit 14A (Step S206). The second display control unit 26C generates the UI screen 34 representing the second script data 32 the designation for which is received at Step S200 in a list format in which the second script data 32 is classified into the units of editing generated at Step S204, and displays the UI screen 34 on the display unit 14A. The user inputs the setting information by operating the input unit 14B while visually recognizing the UI screen 34.

The third reception unit 26D receives the setting information from the input unit 14B (Step S208).

The setting unit 26E generates the third script data 36 by setting the setting information received at Step S208 to the second script data 32 the designation for which is received at Step S200 (Step S210). The setting unit 26E then stores the generated third script data 36 in the storage unit 16 (Step S212). This routine is then ended.

Next, the following describes a procedure of generating the performance voice data 38.

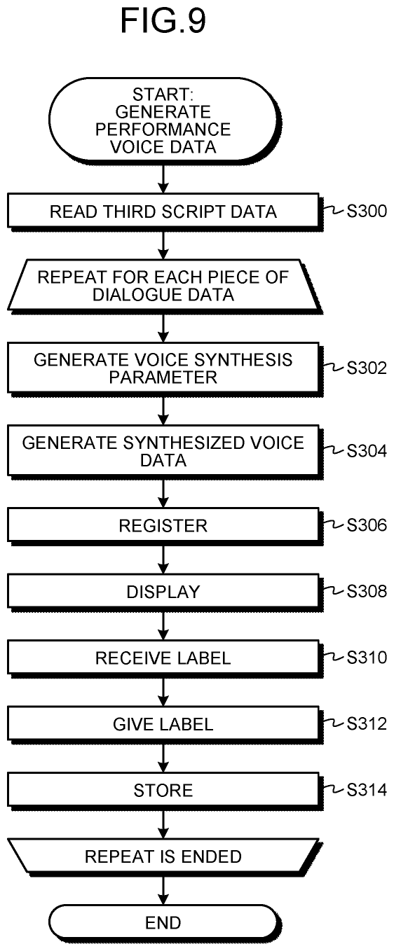

FIG. 9 is a flowchart representing an example of a procedure of generation processing for the performance voice data 38.

The performance voice data generation unit 28 reads a piece of the third script data 36 to be a generation target for the performance voice data 38 (Step S300).

The performance voice data generation unit 28 then executes the processing at Step S302 to Step S314 for each of the pieces of dialogue data corresponding to the respective dialogue IDs.

Specifically, the voice generation unit 28A generates the voice synthesis parameter (Step S302). The voice generation unit 28A generates, for the dialogue data corresponding to the dialogue ID, the voice synthesis parameter of the voice data that is implemented by using the voice dictionary data identified with a corresponding dictionary ID with a corresponding synthesis rate. The voice generation unit 28A further generates the voice synthesis parameter such as Prosody data corresponding to the dialogue data by correcting the generated voice synthesis parameter in accordance with corresponding feeling data and voice quality information.

The voice generation unit 28A also generates the synthesized voice data (Step S304). The voice generation unit 28A generates, for the dialogue data, the synthesized voice data that is implemented by using the voice dictionary data identified with a corresponding dictionary ID with a corresponding synthesis rate.

The voice generation unit 28A then registers, in the storage unit 16, the dialogue voice data 39 in which the dialogue ID, the dialogue data, the voice synthesis parameter generated at Step S302, and the synthesized voice data generated at Step S304 are at least associated with each other (Step S306).

The third display control unit 28B displays the dialogue voice data 39 generated at Step S306 on the display unit 14A (Step S308). For example, the display unit 14A displays a piece of the dialogue voice data 39 in the performance voice data 38 illustrated in FIG. 6. The user inputs one or a plurality of labels for the dialogue voice data 39 by operating the input unit 14B while referring to the displayed dialogue voice data 39.

The label reception unit 28C receives, from the input unit 14B, the label input by the user and the dialogue ID included in the dialogue voice data 39 to which the label is given (Step S310). The label giving unit 28D gives the label received at Step S310 to the dialogue voice data 39 (Step S312). Specifically, the label giving unit 28D associates the received label with the received dialogue ID in the dialogue voice data 39 to be registered in the dialogue voice data 39.

The label giving unit 28D stores the dialogue voice data 39 to which the label is given in the storage unit 16 (Step S314). That is, the label giving unit 28D stores the dialogue voice data 39 corresponding to the one dialogue ID in the storage unit 16 by further giving the label to the dialogue voice data 39 registered at Step S306.

The performance voice data generation unit 28 repeats the processing at Step S302 to Step S314 for each of the pieces of dialogue data included in the third script data 36 read at Step S300. Through these pieces of processing, the performance voice data generation unit 28 can generate the performance voice data 38 constituted of groups of the dialogue voice data 39 for the respective pieces of dialogue data included in the third script data 36. This routine is then ended.

As described above, the information processing device 10 according to the present embodiment includes the output unit 24. The output unit 24 outputs the second script data 32 in which the dialogue data of the dialogue included in the first script data 30 is associated with the utterer data of the utterer of the dialogue from the first script data 30 as the basis for performance.

The script 31 has a configuration including various pieces of information such as the names of the utterers and stage directions in addition to the dialogues to be actually uttered. In the related art, a technique of synthesizing voices for performance in accordance with an intention of the script 31 has not been disclosed. Specifically, there are various script patterns of the script 31, and a technique of synthesizing voices to be output from the script 31 has not been disclosed.

For example, in a case of a typical play, the script 31 is configured by combining various pieces of additional information such as names of utterers, stage directions, and dialogues. A performer who utters the dialogue understands behavior of the utterer performed by himself/herself, make a complement by imagination in some cases, and gives a performance.

In a case of realizing performance such as a play on a stage by using a voice synthesis technique, in the related art, a computer system cannot analyze additional information and the like such as the stage directions in the script 31. Thus, the user is required to perform setting and checking in accordance with content of the script 31. Additionally, in the related art, the user is required to manually prepare data in a special format for analyzing the script 31.

On the other hand, in the information processing device 10 according to the present embodiment, the output unit 24 outputs the second script data 32 in which the dialogue data of the dialogue included in the first script data 30 is associated with the utterer data of the utterer of the dialogue from the first script data 30 as the basis for performance.

Due to this, the information processing device 10 according to the present embodiment can automatically provide data that can output performance voice in accordance with an intention of the script 31 by processing the first script data 30 by the information processing device 10. That is, the information processing device 10 according to the present embodiment can automatically extract the dialogue data and the utterer data included in the script 31 to be provided as the second script data 32.

Thus, the information processing device 10 according to the present embodiment can provide data that can output performance voice in accordance with an intention of the script 31.

The information processing device 10 according to the present embodiment generates the second script data 32 in which the dialogue data is associated with the utterer data for each of the pieces of dialogue data included in the first script data 30. Due to this, the information processing device 10 can generate the second script data 32 in which pairs of the dialogue data and the utterer data are arranged in order of appearance of the dialogues that appear in the script 31. Thus, the information processing device 10 can provide data that can perform voice synthesis along the order of appearance of the dialogue data included in the second script data 32 in addition to the effects described above.

Next, the following describes a hardware configuration of the information processing device 10 according to the present embodiment.

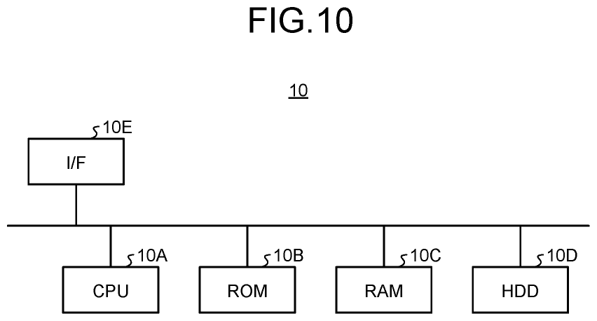

FIG. 10 is an example of a hardware diagram of the information processing device 10 according to the present embodiment.

The information processing device 10 according to the present embodiment includes a control device such as a CPU 10A, a storage device such as a read only memory (ROM) 10B and a random access memory (PAM) 10C, a hard disk drive (HDD) 10D, an I/F 10E that is connected to a network to perform communication, and a bus 10F that connects the respective units.

A computer program executed by the information processing device 10 according to the present embodiment is embedded and provided in the ROM 10B, for example.

The computer program executed by the information processing device 10 according to the present embodiment may be recorded in a computer-readable recording medium such as a compact disk read only memory (CD-ROM), a flexible disk (FD), a compact disk recordable (CD-R), and a digital versatile disk (DVD) to be provided as a computer program product, as an installable or executable file.

Furthermore, the computer program executed by the information processing device 10 according to the present embodiment may be stored in a computer connected to a network such as the Internet and provided by being downloaded via the network. The computer program executed by the information processing device 10 according to the present embodiment may be provided or distributed via a network such as the Internet.

The computer program executed by the information processing device 10 according to the present embodiment may cause a computer to function as the respective units of the information processing device 10 described above. In this computer, the CPU 10A can read out the computer program from a computer-readable storage medium onto a main storage device to be executed.

In the embodiment described above, it is assumed that the information processing device 10 is configured as a single device. However, the information processing device 10 may be configured by a plurality of devices that are physically separated from each other and communicably connected to each other via a network and the like.

For example, the information processing device 10 may be configured as an information processing device including the acquisition unit 22 and the output unit 24, an information processing device including the second generation unit 26, and an information processing device including the performance voice data generation unit 28.

The information processing device 10 according to the embodiment described above may be implemented as a virtual machine that operates on a cloud system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a hardware processor configured to function as:
an output unit configured to output second script data in which dialogue data of a dialogue included in first script data is associated with utterer data of an utterer of the dialogue from the first script data as a basis for performance.

2. The information processing device according to claim 1, wherein the output unit outputs the second script data in which the dialogue data is associated with the utterer data as an estimation result of the utterer who utters the dialogue based on the dialogue data.

3. The information processing device according to claim 1, wherein the output unit outputs the second script data in which the utterer data is associated with the dialogue data in which a punctuation mark included in the dialogue is optimized.

4. The information processing device according to claim 1, wherein the output unit estimates a feeling of the utterer at a time of uttering the dialogue data, and outputs the first script data with which feeling data of the estimated feeling is further associated.

5. The information processing device according to claim 1, wherein the output unit outputs the first script data in which dialogue identification information of the dialogue data is further associated with each piece of the dialogue data.

6. The information processing device according to claim 1, wherein the output unit outputs the second script data as an output result obtained by inputting the first script data to a first learning model.

7. The information processing device according to claim 1, wherein the output unit includes:
a specification unit configured to specify a script pattern at least representing an arrangement of the utterer and the dialogue included in the first script data;
an analysis unit configured to analyze the dialogue data and the utterer data included in the first script data based on the script pattern; and
a first generation unit configured to generate the second script data in which the analyzed dialogue data and utterer data are at least associated with each other.

8. The information processing device according to claim 7, wherein the specification unit specifies the script pattern of the first script data as an output result obtained by inputting the first script data to a second learning model.

9. The information processing device according to claim 7, wherein the hardware processor is configured to function as:
a reception unit configured to receive a correction instruction for the script pattern; and
a correction unit configured to correct the script pattern in accordance with the correction instruction.

10. The information processing device according to claim 1, wherein the hardware processor is configured to function as:
a reception unit configured to receive setting information including dictionary identification information of voice dictionary data corresponding to the dialogue data included in the second script data; and
a second generation unit configured to generate third script data in which the received setting information is associated with the corresponding dialogue data in the second script data.

11. The information processing device according to claim 10, wherein the reception unit receives the setting information further including voice quality information at a time when the dialogue of the dialogue data is uttered.

12. The information processing device according to claim 10, wherein the hardware processor is configured to function as:
a performance voice data generation unit configured to generate performance voice data including dialogue voice data in which the dialogue data included in the third script data is associated with at least one of a voice synthesis parameter for generating synthesized voice of the dialogue data using the voice dictionary data identified with the corresponding dictionary identification information and synthesized voice data of the synthesized voice.

13. The information processing device according to claim 12, wherein the hardware processor is configured to function as:
a label giving unit configured to give one or a plurality of labels to the dialogue voice data.

14. An information processing method executed by a computer, the information processing method comprising:
outputting second script data in which dialogue data of a dialogue included in first script data is associated with utterer data of an utterer of the dialogue from the first script data as a basis for performance.

15. An information processing computer program product having a non-transitory computer readable medium including programmed instructions, wherein the instructions, when executed by a computer, cause the computer to execute:
outputting second script data in which dialogue data of a dialogue included in first script data is associated with utterer data of an utterer of the dialogue from the first script data as a basis for performance.
